(19) United States
(12) Patent Application Publication
(10) Pub. No.: US 2009/0243794 A1
(43) Pub. Date: Oct. 1, 2009

(54) CAMERA MODULES COMMUNICATING WITH COMPUTER SYSTEMS

(76) Inventor: Neil MORROW, McKinney, TX (US)

Correspondence Address: PATENT PROSECUTION;O2MIRCO , INC., 3118 PATRICK HENRY DRIVE, SANTA CLARA, CA, 95054, US

(21) Appl. No.: 12/408,925

(22) Filed: Mar. 23, 2009

Related U.S. Application Data
(60) Provisional application No. 61/070,548, filed on Mar. 24, 2008.

(51) Int. Cl. G05B 19/00; H04N 7/18; H04B 7/00; G06K 7/00; G10L 15/00; G06F 21/00

(52) U.S. Cl. 340/5.52; 348/156; 455/41.2; 340/10.1; 704/231; 713/186; 704/E15.001; 348/E07.085

(57) ABSTRACT

A camera module includes an image sensor, a first signal processor, a bus interface, and a security device interface. The image sensor acquires an image data input. The first signal processor is coupled to the image sensor to receive the image data input, exchange data with a security device, and exchange data with a computer system which includes a second signal processor. The bus interface is coupled to the first signal processor to exchange data between the first signal processor and the second signal processor. The security device interface is coupled to the first signal processor to exchange data between the first signal processor and the security device.

### RELATED APPLICATION

This application claims priority to U.S. Provisional Application No. 61/070,548, filed on Mar. 24, 2008, which is hereby incorporated by reference in its entirety.

### BACKGROUND

Passwords have long been used as a security measure against unauthorized access to data in a computer. However, the computer can verify the legitimacy of the password, but not the legitimacy of the user. A problem associated with passwords is that they may not provide reliable security. In fact, hackers can use certain software to crack the passwords.

To solve this problem, biometrics authentication has developed. Biometrics authentication is a more secure form of authentication than typing passwords. Biometrics authentication is a technique that identifies people based on their unique physical characteristics or behavioral traits. Facial recognition is one kind of biometrics authentication which identifies people based on their facial characteristics. Typically, a camera is used for obtaining a user's face image for the facial recognition. However, the functions that the camera performs are simple. For example, the camera captures the user's face image, formats the face image and then transmits the face image to an electronic device, e.g., a computer system.

### SUMMARY

A camera module includes an image sensor, a first signal processor, a bus interface, and a security device interface. The image sensor acquires an image data input. The first signal processor is coupled to the image sensor to receive the image data input, exchange data with a security device, and exchange data with a computer system which includes a second signal processor. The bus interface is coupled to the first signal processor to exchange data between the first signal processor and the second signal processor. The security device interface is coupled to the first signal processor to exchange data between the first signal processor and the security device.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 is a diagram of an authentication system according to one embodiment of the present invention.

FIG. 2 is a diagram of an authentication system according to another embodiment of the present invention.

FIG. 3 is a flowchart of operations performed by a camera module according to one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Embodiments described herein may be discussed in the general context of computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “enabling,” “detecting,” “determining,” “examining,” “creating,” “obtaining,” “exchanging” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide a camera module and an authentication system. The camera module includes a security device interface and can exchange data with a security device via the security device interface. The authentication system can authenticate a user by comparing an image data input from the user acquired by the camera module with predetermined biometric profiles. Advantageously, the predetermined biometric profiles can be encrypted by a cryptographic method and stored in the security device. Thus, the security of the predetermined biometric profiles can be enhanced. Moreover, the camera module can execute a biometric software application to exchange data with the security device to obtain the predetermined biometric profiles for biometric authentication.

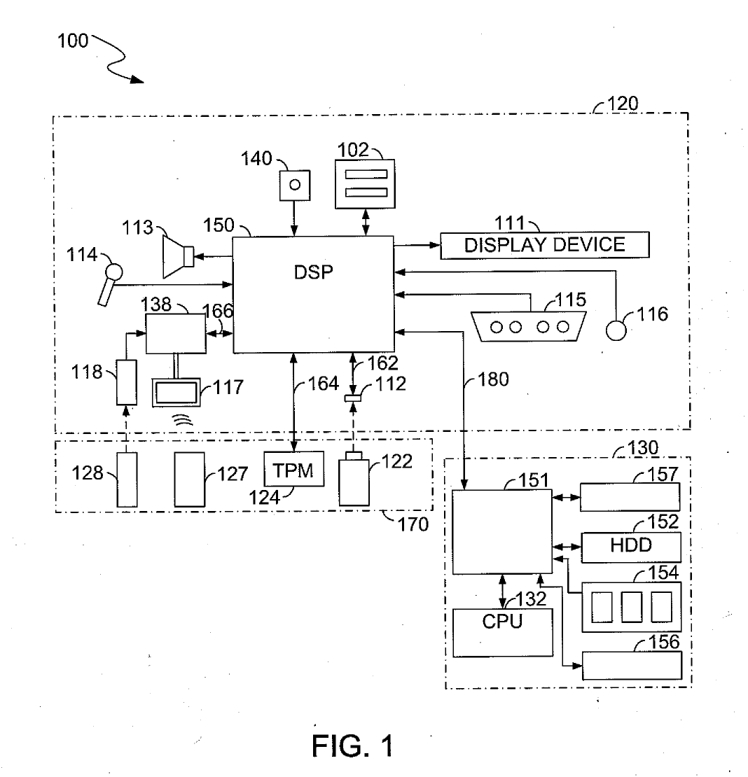

FIG. 1 illustrates a diagram of an authentication system 100 according to one embodiment of the present invention. The authentication system 100 can perform biometric authentication, for example, facial recognition. However, the invention is not so limited. Other types of biometric authentication such as voice recognition can also be accomplished within the scope and spirit of the claimed invention. A signal block in FIG. 1 may be described as performing a function or functions; however, in actual practice, the function or functions performed by that block may be performed in a single component or across multiple components, and/or may be performed using hardware, using software, or using a combination of hardware and software.

In the embodiment of FIG. 1, the authentication system 100 includes a camera module 120, a computer system 130, and a security device 170. The camera module 120 can be an external component (e.g., a USB based webcam peripheral coupled to a computer), or an integrated component (e.g., an integrated camera module of an external liquid crystal display (LCD) monitor).

The camera module 120 can acquire an image data input, e.g., data of image frames of a user, and can exchange data with the computer system 130, for example, to provide the image data input to the computer system 130. The camera module 120 can also exchange data with the security device 170. The security device 170 can store data, e.g., predetermined biometric profiles which are encrypted by a cryptographic method and used for biometric authentication. In one embodiment, the camera module 120 can execute a biometric software application to exchange data with the security device 170 to obtain the predetermined biometric profiles and to compare the image data input with the predetermined biometric profiles for biometric authentication. The computer system 130 includes a signal processor, e.g., CPU 132, a system core logic 151, a local storage medium (e.g., HDD 152, main memory 154), a remote server 156 and a main display 157, and can be accessed if the image data input matches with at least one of the predetermined biometric profiles, in one embodiment.

Advantageously, the predetermined biometric profiles stored in the security device 170 are encrypted by a security key according to a cryptographic algorithm, in one embodiment. In one such embodiment, the security device 170 can provide the security key and the cryptographic algorithm. The cryptographic algorithm can be, but is not limited to, a data encryption standard (DES), a triple data encryption standard (Triple DES), and an advanced encryption standard (AES) cryptographic method. The security key can be, e.g., at least 64 bits in length.

In one embodiment, the camera module 120 can exchange data with the security device 170 to obtain the security key and the cryptographic algorithm and can encrypt the predetermined biometric profiles by the security key according to the cryptographic algorithm. Alternatively, the CPU 132 in the computer system 130 can encrypt the predetermined biometric profiles by the security key according to the cryptographic algorithm. Thus, the predetermined biometric profile stored in the security device 170 can be protected. As such, the security of the data exchange, for example, the security of acquiring the predetermined biometric profiles, can be enhanced.

The security device 170 can include, but is not limited to, a contact smart card 128, a contactless smart card 127, a trusted platform module (TPM) 124, and a USB token 122. The contact smart card 128 is also called an integrated chip card (ICC) which is specified by an ISO (International Organization for Standardization) standard, such as ISO 7816 standard. The contactless smart card 127 can be a contactless ICC or near field communication (NFC) device, e.g., a NFC tag, which is specified by an ISO standard, such as an ISO 14443 standard, or ISO 15693 standard, or an ISO 18092 standard, or operates with data structures defined by the NFC Forum, and may operate at a radio frequency, e.g., 13.56 MHz. The TPM 124 is a crypto processor that can store cryptographic keys that protect information, and can be defined by the trusted computing group (TCG). The USB token 122 is a walk-up dongle device which may operate ISO 7816 protocols, and may operate a USB security class device interface.

In one embodiment, the predetermined biometric profiles are stored in the security device 170 and can be encrypted by the DSP 150 in the camera module 120 or the CPU 132 in the computer system 130. In another embodiment, the predetermined biometric profiles can be stored in the local storage medium and/or the remote server 156 in the computer system 130, and can be encrypted by the TPM 124 using the cryptographic/security key stored in the TPM 124, the local storage medium, or the remote server 156. In another embodiment, the predetermined biometric profiles stored in the contact smart card 128, contactless smart card 127, and the USB token 122 can be encrypted by the TPM 124.

In the embodiment of FIG. 1, the camera module 120 includes an image sensor 140, a signal processor (e.g. digital signal processor (DSP) 150), a bus interface 180, security device interfaces 162, 164 and 166. The security device interfaces 162, 164 and 166 can be, but are not limited to, a universal serial bus (USB) bus, a low-pin-count (LPC) bus, a peripheral controller interface (PCI) bus, or a PCI express bus.

The camera module 120 may further include a smart card reader 138, a smart card connector 118, an antenna 117, an auxiliary display device 111, a USB port 112, an audio output device (e.g., speaker 113), an audio input device (e.g., microphone 114), one or more user interfaces (e.g., a push button interface 115, an infrared interface (IR) interface 116), and a SRAM 102. In one embodiment, the smart card reader 138 can be embedded into the DSP 150. In one embodiment, the DSP 150, the image sensor 140 and the antenna 117 can reside on a single printed circuit board (PCB).

The image sensor 140 can be a complementary metal oxide semiconductor (CMOS) image sensor. The image sensor 140 can acquire an image data input (captures image frames) and send the image data input to the DSP 150. The computer system 130 can also receive the image data input via the DSP 150 and the bus interface 180. In one embodiment, the image sensor 140 can be a separate device that connects to the DSP 150 by a cable and can support video graphics array (VGA) resolution.

The DSP 150 can receive the image data input from the image sensor 140 and format the image data input. Furthermore, the DSP 150 can exchange data with the security device 170 via the security device interfaces 162, 164 and 166, the smart card reader 138, the smart card connector 118, the antenna 117, and the USB port 112 to obtain the predetermined biometric profiles for biometric authentication. In one embodiment, the DSP 150 can also exchange data with the computer system 130 via the bus interface 180. The bus interface 180 can be a USB, a PCI express, or the like. The bus interface 180 can be connected to the computer system 130 directly or by means of an external walk-up port, for example, a USB port.

The smart card reader 138 is coupled to the security device interface 166 for exchanging data between the DSP 150 and the security device 170. In one embodiment, the smart card reader 138 can be a contact smart card reader. In this instance, the smart card reader 138 provides connectivity/communication between the contact smart card 128 and the DSP 150. The smart card connector 118 can establish physical connectivity between the contact smart card 128 and the smart card reader 138.

In one embodiment, the smart card reader 138 can be a contactless smart card reader, e.g., a NFC reader. In this instance, the smart card reader 138 provides connectivity/communication between the contactless smart card 127 and the DSP 150. The antenna 117 can exchange data between the contactless smart card 127 and the smart card reader 138. As an example, the antenna 117 may have a communication length range of 0 cm (centimeter) to 10 cm. The antenna 117 can be integrated in the camera module 120. Thus, the cost and power consumption of the camera module 120 can be reduced.

In one embodiment, the smart card reader 138 can be a combo smart card reader which can support more than one connectivity method and can provide connectivity to both contact smart card 128 and contactless smart card 127.

Therefore, the DSP 150 can execute a biometric software application to obtain the image data input and exchange data with the security device 170 to obtain the predetermined biometric profiles, and to compare the image data input with the predetermined biometric profiles for biometric authentication. In another embodiment, the predetermined biometric profiles can be stored in the HDD 152, the main memory 154, and the remote server 156. In this instance, the DSP 150 can also exchange data with the HDD 152, the main memory 154, and the remote server 156 via the system core logic 151 and the bus interface 180 to obtain the predetermined biometric profiles.

Moreover, the camera module 120 can be triggered to enable the biometric authentication. For example, the DSP 150 in the camera module 120 can automatically enable the biometric authentication when the camera module 120 detects that a contact smart card 128 is coupled to the camera module 120, or a contactless smart card 127 is placed near the camera module 120, or when the camera module 120 detects that a person is in front of the image sensor 140.

In one embodiment, the predetermined biometric profiles can be created during a enrollment process. During the enrollment process, the DSP 150 can execute the biometric software application to create and obtain a predetermined biometric profile of the user. For example, to obtain the predetermined biometric profiles, a person can stand in front of the image sensor 140 to get his/her face images taken. As such, the DSP 150 can store the face images, e.g., in the security device 170, and/or the HDD 152, and/or the main memory 154, and/or the remote server 156. As such, the biometric software application operating on the DSP 150 can compare the predetermined biometric profiles created through the enrollment process with the biometric data input acquired by the camera module 120 to provide authentication based upon a result of the comparison.

The DSP 150 may include other functions such as image compression and audio formatting for an audio input, and operate a standard USB Video Class protocol. The DSP 150 can compress the image data input using standard video compression techniques, e.g., Joint Photographic Experts Group (JPEG) or Motion Picture Experts Group (MPEG) techniques. Thus, data describing the image data input, e.g., characteristic of a human face, can be created by the DSP 150 according to the video compression techniques and can be exchanged between the DSP 150 and the security device 170 or computer system 130.

The SRAM 102 coupled to the DSP 150 can be of at least one image frame size (frame buffer size). By means of examining pixel information, the DSP 150 can determine the presence and position of an object, and can also determine the motion of an object in the image frames, for example, an object moving across a space, or the presence of an amount of light captured by the image sensor 140, in one embodiment. Consequently, data or data structure can be created by the DSP 150 to describe the object and the motion. The data structures associated with motion related objects can include, but are not limited to, the relative speed of motion and the area in the image frames where the motion occurred. The data structures associated with light intensity objects may include, but are not limited to, the quantity of light and color information of light. Accordingly, the DSP 150 can provide a directional vector to indicate the data structure.

The auxiliary display device 111 can be controlled by the DSP 150 to output and display an image. In other words, the DSP 150 can operate codes to communicate with the auxiliary display device 111. The auxiliary display device 111 can be a liquid crystal display (LCD) or other display devices. In one embodiment, the auxiliary display device 111 can support SideShow® technology published by Microsoft® and can provide an alternate graphical user interface (GUI), which may be useful to check a calendar, obtain Really Simple Syndication (RSS) feeds, or acquire other information from the computer system 130. The auxiliary display device 111 can display time, dates, massages, digital video content and other information, in one embodiment.

In one embodiment, an auxiliary device (not shown) located in the computer system 130 and controlled by a DSP (not shown) in the computer system 130 can serve as the auxiliary display device 111.

Advantageously, in one embodiment, the DSP (not shown) in the computer system 130 for controlling the auxiliary device located in the computer system 130 can serve as the DSP 150 in the camera module 120. Consequently, the cost of the camera module 120 can be reduced.

The camera module 120 can also enable user interactions with the camera module 120 via the user interfaces, e.g., push button interface 115, IR interface 116, or a touch screen interface. As a result, a user can control the cameral module 120 using the input interfaces. The DSP 150 can execute certain functions according to the input received via the input interfaces, thus interacting with the user. Furthermore, the camera module 120 may include an alarm clock function which can be programmed by the push button interface 115 and/or the IR interface 116, or through the biometric software application operating on the DSP 150.

The audio output device, e.g., the speaker 113 can be controlled by the DSP 150 for outputting audio information. As such, the speaker 113 can provide audio alarms to represent different states of the camera module 120, for example, audio alarms to inform the user if the biometric recognition is achieved or failed. Moreover, the speaker 113 may be used for other functions such as playing music, and the DSP 150 may be used for rendering digital music content, in one embodiment.

The audio input device, e.g., the microphone 114 can be controlled by the DSP 150 and can acquire an audio data input and provide the audio data input to the DSP 150. The audio data input can support a number of audio functions. For example, the audio data input can be used to synchronize with lip movements to improve facial recognition. The audio data input can also support voice recognition similar to the facial recognition. Furthermore, the audio data input can support echo cancellation by providing echo information in the audio data input.

Advantageously, in one embodiment, if the computer system 130 is powered off, the DSP 150 can still function and execute a software application to communicate with other components in the camera module 120, such as the user interfaces 115/116, auxiliary display device 111, speaker 113, microphone 114, the image sensor 140, and the SRAM 102.

As described hereinabove in relation to FIG. 1, the DSP 150 can execute a biometric software application to obtain the image data input and exchange data with the security device 170 and/or the computer system 130 to obtain the predetermined biometric profiles, and to compare the image data input with the predetermined biometric profiles for biometric authentication. Alternatively, the CPU 132 in the computer system 130 can perform similar functions as the DSP 150 in the camera module 120. For example, the CPU 132 can execute a biometric software application to exchange data with the camera module 120 to receive the image data input via the bus interface 180, and to exchange data with the security device 170, and to compare the image data input with the predetermined biometric profiles for biometric authentication.

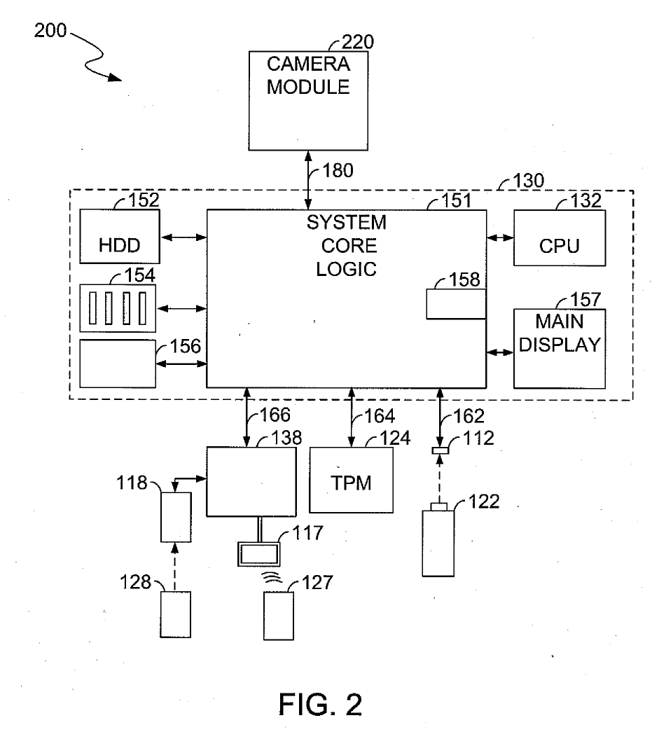

FIG. 2 illustrates a diagram of an authentication system 200 according to another embodiment of the present invention. The authentication system 200 can perform biometric authentication, for example, facial recognition and voice recognition. In the embodiment of FIG. 2, the authentication system 200 includes the camera module 220, the bus interface 180, the computer system 130, the security device interfaces 162, 164 and 166, the smart card reader 138, the smart card connector 118, the antenna 117, the USB port 112, and the security device. The security device can include, but is not limited to, a contact smart card 128, a contactless smart card 127, a trusted platform module (TPM) 124, and a USB token 122. Elements labeled the same in FIG. 1 have similar functions. A signal block in FIG. 2 may be described as performing a function or functions; however, in actual practice, the function or functions performed by that block may be performed in a single component or across multiple components, and/or may be performed using hardware, using software, or using a combination of hardware and software.

In the embodiment of FIG. 2, the computer system 130 includes the CPU 132, the system core logic 151, the local storage medium (e.g., HDD 152, main memory 154), a remote server 156, and the main display 157. The system core logic 151 coupled to the camera module 220, local storage medium, the remote server 156, the security device and the CPU 132 can enable input/output data exchange among the components in the authentication system 200. The system core logic 151 may include an integrated graphics controller 158 that generates a video output and transmits the video output to a video output device (not shown), for example, a digital video interactive (DVI) video output device. The system core logic 151 may also generate and transmit an audio output to an audio output device (not shown).

The camera module 220 can acquire the image data input and provide the image data input to the computer system 130. The local storage medium, the remote server 156 and the security devices coupled to the camera module 220 via the system core logic 151 can store data, e.g., the predetermined biometric profiles which are encrypted by the security key according to the cryptographic algorithm and used for biometric authentication. In one embodiment, the security device can provide the security key and the cryptographic algorithm. In another embodiment, the security key can be predetermined and can be stored in the local storage medium and the remote server 156.

In one embodiment, the CPU 132 can exchange data with the local storage medium, the remote server 156, and the security device via the system core logic 151 to obtain the security key and the cryptographic algorithm, and can encrypt the predetermined biometric profiles by the security key according to the cryptographic algorithm. Therefore, the security of the data exchange, for example, the security of acquiring the predetermined biometric profiles, can be enhanced.

Furthermore, the CPU 132 can execute the biometric software application to exchange data with the camera module 220 via the bus interface 180 to obtain the image data input and to compare the image data input with the predetermined biometric profiles for biometric authentication. The CPU 132 can authorize access to the computer system 130 if the image data input matches with at least one of the predetermined biometric profiles.

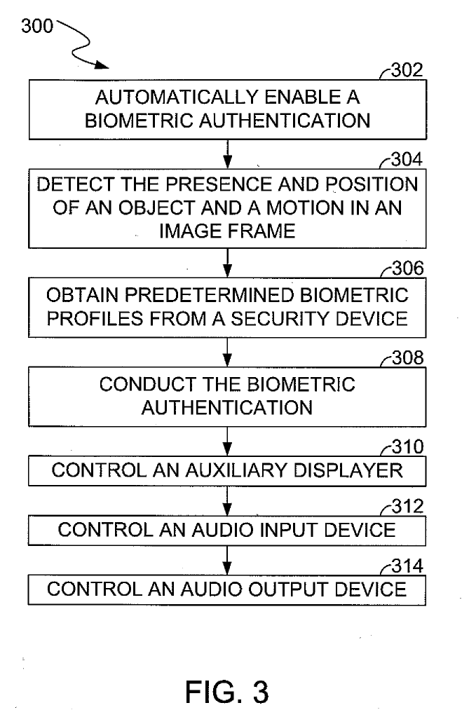

FIG. 3 illustrates a flowchart 300 of operations performed by a camera module according to one embodiment of the present invention. The operations illustrated in the FIG. 3 are performed by the DSP 150 in the camera module 120. FIG. 3 is described in combination with the FIG. 1.

At 302, a biometric authentication can be automatically enabled. For example, when the DSP 150 detects that the contact smart card 128 is coupled to the camera module 120 or the contactless smart card 127 is placed near the camera module 120, or when the camera module 120 detects that a person is in front of the image sensor 140, the biometric authentication can be enabled.

At 304, the presence and position of an object and a motion in an image frame can be determined. For example, the SRAM 102 coupled to the DSP 150 can be of at least one image frame size (frame buffer size). By means of examining the pixel information, the DSP 150 can determine the presence and position of the object and the motion. Data or data structures can be created by the DSP 150 to describe the detected object and motion.

At 306, the predetermined biometric profiles can be obtained. The DSP 150 can execute a biometric software application to exchange data with the security device 170, the HDD 152, the main memory 154, and/or the remote server 156 in the computer system 130 to obtain the predetermined biometric profiles.

At 308, the biometric authentication is conducted. The DSP 150 can execute the biometric software application to compare the image data input with the predetermined biometric profiles for biometric authentication.

At 310, an auxiliary displayer, e.g., the auxiliary display device 111, can be controlled by the DSP 150 to provide a SideShow®, which may be useful to check a calendar, obtain Really Simple Syndication (RSS) feeds or the like, or acquire other information from the computer system 130.

At 312, an audio input device, e.g., the microphone 114, can be controlled by the DSP 150 to acquire an audio data input. The audio data input can support a number of audio functions as described above. The audio data input can also be used for voice recognition.

At 314, an audio output device, e.g., the speaker 113, can be controlled by the DSP 150 to output audio information. The speaker 113 can provide a number of functions, such as provide audio alarms to inform the user if the biometric authentication is achieved or failed. The speaker 113 may be used for other functions such as playing music, and the DSP 150 may be used for rendering digital music content, in one embodiment.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

1. A camera module comprising:
an image sensor operable for acquiring an image data input;
a first signal processor coupled to said image sensor operable for receiving said image data input and for exchanging data with a security device and for exchanging data with a computer system comprising a second signal processor;
a bus interface coupled to said first signal processor operable for exchanging data between said first signal processor and said second signal processor; and
a security device interface coupled to said first signal processor operable for exchanging data between said first signal processor and said security device.

2. The camera module of claim 1, wherein said security device comprises a near field communication (NFC) tag.

3. The camera module of claim 1, further comprising;
a smart card reader coupled to said security device interface operable for exchanging data between said first signal processor and said security device.

4. The camera module of claim 3, wherein said smart card reader comprises a NFC reader.

5. The camera module of claim 3, further comprising:
an antenna coupled to said smart card reader operable for exchanging data between said first signal processor and said security device.

6. The camera module of claim 5, wherein said image sensor, said first signal processor, and said antenna reside on a single printed circuit board.

7. The camera module of claim 3, wherein said smart card reader is embedded into said first signal processor.

8. The camera module of claim 1, wherein said security device stores a plurality of predetermined biometric profiles which are encrypted by a security key according to a cryptographic algorithm.

9. The camera module of claim 8, wherein said first signal processor executes a software application operable for exchanging data with said security device via said security device interface to obtain said plurality of predetermined biometric profiles and for comparing said image data input with said predetermined biometric profiles for biometric authentication.

10. The camera module of claim 8, wherein said second signal processor executes a software application operable for exchanging data with said security device to obtain said plurality of predetermined biometric profiles and for comparing said image data input with said predetermined biometric profiles for biometric authentication.

11. The camera module of claim 1, wherein said security device is selected from the group consisting of a contact smart card, a contactless smart card, an universal serial bus (USB) token and a trusted platform module (TPM).

12. The camera module of claim 1, wherein said data exchanged between said first signal processor and said security device comprises characteristic of a human face and is created by said first signal processor according to said image data input and a video compression technique.

13. The camera module of claim 1, wherein said first signal processor is operable for determining presence and position of an object by examining pixel information of said image data input.

14. The camera module of claim 1, wherein said first signal processor is operable for detecting motion of an object by examining pixel information of said image data input.

15. The camera module of claim 1, further comprising:
a display device controlled by said first signal processor operable for displaying an image.

16. The camera module of claim 15, wherein said display device is operable for displaying time, dates, and messages.

17. The camera module of claim 1, further comprising:
an audio input device controlled by said first signal processor operable for acquiring an audio data input and for providing said audio data input to said first signal processor for voice recognition.

18. The camera module of claim 1, further comprising:
an audio output device controlled by said first signal processor operable for outputting audio information.

19. An authentication system, comprising:
a camera module, comprising:
an image sensor operable for acquiring an image data input;
a first signal processor coupled to said image sensor operable for receiving said image data input and for exchanging data with a security device which stores a plurality of predetermined biometric profiles; and
a security device interface coupled to said first signal processor operable for exchanging data between said first signal processor and said security device;
a computer system coupled to said camera module, comprising:
a second signal processor operable for authorizing access to said computer system if said image data input matches with at least one of said plurality of predetermined biometric profiles; and
a bus interface coupled to said first signal processor and said computer system operable for exchanging data between said first signal processor and said computer system.

20. The authentication system of claim 19, further comprising;
a smart card reader coupled to said security device interface operable for exchanging data between said first signal processor and said security device.

21. The authentication system of claim 20, wherein said smart card reader is embedded into said first signal processor.

22. The authentication system of claim 20, further comprising:
an antenna coupled to said smart card reader operable for exchanging data between said first signal processor and said security device.

23. The authentication system of claim 22, wherein said image sensor, said first signal processor, and said antenna reside on a single printed circuit board.

24. The authentication system of claim 19, wherein said plurality of predetermined biometric profiles are encrypted by a security key according to a cryptographic algorithm.

25. The authentication system of claim 19, wherein said first signal processor executes a software application operable for exchanging data with said security device via said security device interface to obtain said plurality of predetermined biometric profiles and for comparing said image data input with said predetermined biometric profiles for biometric authentication.

26. The authentication system of claim 19, wherein said second signal processor executes a software application operable for exchanging data with said security device via said security device interface to obtain said plurality of predetermined biometric profiles and for comparing said image data input with said predetermined biometric profiles for biometric authentication.

27. The authentication system of claim 19, wherein said camera module further comprises a display device operable for displaying time, dates, and messages.

28. A camera module comprising:
an image sensor operable for acquiring an image data input;
a first signal processor coupled to said image sensor operable for receiving said image data input, and for exchanging data with a storage medium which stores a plurality of predetermined biometric profiles, and for comparing said image data input with said plurality of predetermined biometric profiles for biometric authentication, and for exchanging data with a computer system comprising a second signal processor; and
a bus interface coupled to said first signal processor operable for exchanging data between said first signal processor and said second signal processor.

29. The camera module of claim 28, wherein said storage medium comprises a security device.

30. The camera module of claim 29, further comprising;
a smart card reader coupled to said first signal processor operable for exchanging said plurality of predetermined biometric profiles between said first signal processor and said security device.

31. The camera module of claim 30, further comprising:
an antenna coupled to said smart card reader operable for exchanging said plurality of predetermined biometric profiles between said first signal processor and said security device.
